(19) United States
(12) Patent Application Publication
(10) Pub. No.: US 2016/0001670 A1
(43) Pub. Date: Jan. 7, 2016

(54) SYSTEM AND METHOD FOR BATTERY MANAGEMENT

(71) Applicant: FORD GLOBAL TECHNOLOGIES, LLC, Dearborn, MI (US)

(72) Inventor: Tae-Kyung LEE, Ann Arbor, MI (US)

(21) Appl. No.: 14/320,982

(22) Filed: Jul. 1, 2014

(51) Int. Cl. B60L 11/18; H02J 7/00

(52) U.S. Cl. CPC B60L 11/1851; H02J 7/007; B60L 11/1809

(57) ABSTRACT

A vehicle includes a battery pack and at least one controller. The at least one controller is programmed to provide injection current inputs to a model configured to simulate, in response to the inputs, terminal voltage outputs of the battery pack. The at least one controller is further programmed to output power limits for the battery pack based on a regression of the injection current inputs and terminal voltage outputs.

### TECHNICAL FIELD

The present disclosure relates to battery management techniques capable of estimating parameters of elements forming a battery model for providing control of an associated battery.

### BACKGROUND

Hybrid electric vehicles (HEV) utilize a combination of an internal combustion engine with an electric motor to provide motive power. This arrangement provides improved fuel economy over a vehicle that has only an internal combustion engine. One method of improving the fuel economy in an HEV is to shutdown the engine during times that the engine operates inefficiently, and is not otherwise needed to propel the vehicle. In these situations, the electric motor is used to provide all of the power needed to propel the vehicle. When the driver power demand increases such that the electric motor can no longer provide enough power to meet the demand, or in other cases such as when the battery state of charge (SOC) drops below a certain level, the engine should start quickly and smoothly in a manner that is nearly transparent to the driver.

The HEV includes a battery management system that estimates values descriptive of the battery pack and/or battery cell present operating conditions. The battery pack and/or cell operating conditions include battery SOC, power fade, capacity fade, and instantaneous available power. The battery management system should be capable of estimating values during changing cell characteristics as cells age over the lifetime of the pack.

### SUMMARY

A hybrid powertrain system includes a battery pack having one or more battery cells and a controller. The controller provides input to a model of the battery pack representing a set of injection currents to cause the model to produce output representing terminal voltages of the battery pack. The controller also generates current limits for the battery pack based on a regression of the input and output.

### BRIEF DESCRIPTION OF THE DRAWINGS

FIG. 1 is a schematic diagram of a hybrid-electric vehicle illustrating typical drivetrain and energy storage components;

FIG. 2 is a schematic diagram of a battery model having current inputs and voltage outputs;

FIG. 3A is a graph illustrating a method to identify the input-to-output relation of a battery model with an impulse current input having a predefined time duration and current magnitude;

FIG. 3B is a graph illustrating a set of predicted battery model voltage responses with respect to a set of current inputs to identify the battery model dynamics;

FIG. 4A is a graph illustrating predicted battery voltage responses with respect to a set of input currents;

FIG. 4B is a graph illustrating a regression curve to predict the battery voltage responses with respect to current input and an estimated current limit during a discharge event;

FIG. 5 is a graph illustrating a regression curve to predict the battery voltage responses with respect to current input and an estimated current limit during a charge event;

FIGS. 6A-6B are graphs illustrating a method to estimate current limits based on a set of predicted battery voltage responses of a battery model equivalent to a set of current inputs injected into the model;

FIGS. 7A-7B are graphs illustrating estimated current limits based on predicted battery voltage responses; and

FIG. 8 is a flow chart of an algorithm for estimating battery current limits and power limits in a battery management system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

A vehicle computing system having one or more controllers may implement a battery management strategy that estimates values descriptive of the present operating condition of the battery and/or one or more battery cells. The battery pack and/or one or more battery cells operating conditions may include battery state of charge, power fade, capacity fade, and instantaneous available power. The battery management strategy may be capable of estimating values as cells age over the lifetime of the pack. The precise estimation of some parameters may improve performance and robustness, and may ultimately lengthen the useful lifetime of the battery pack.

The vehicle computing system may manage and/or communicate with one or more systems/subsystems including a battery management system. The battery management system may estimate battery current limits and power limits from complicated battery models without adding excessive computational efforts to the system. The system may inject a series of current inputs into the battery model to identify the battery dynamic responses for current limit prediction in a simplified function. The system may include an accurate battery model to predict battery responses, but this model may not be able to give explicit expressions for computing available current limits. For instance, black box type models do not have explicit expressions relating inputs and outputs, so that the model responses are not expressed as mathematical expressions. Direct prediction of available current limit of the battery pack may not be possible in a vehicle operating environment. Thus, the battery responses are predicted based on a statistical regression model from a set of battery model inputs and outputs. For the battery system described herein, estimation of some battery pack and/or cell parameters can be realized as discussed below.

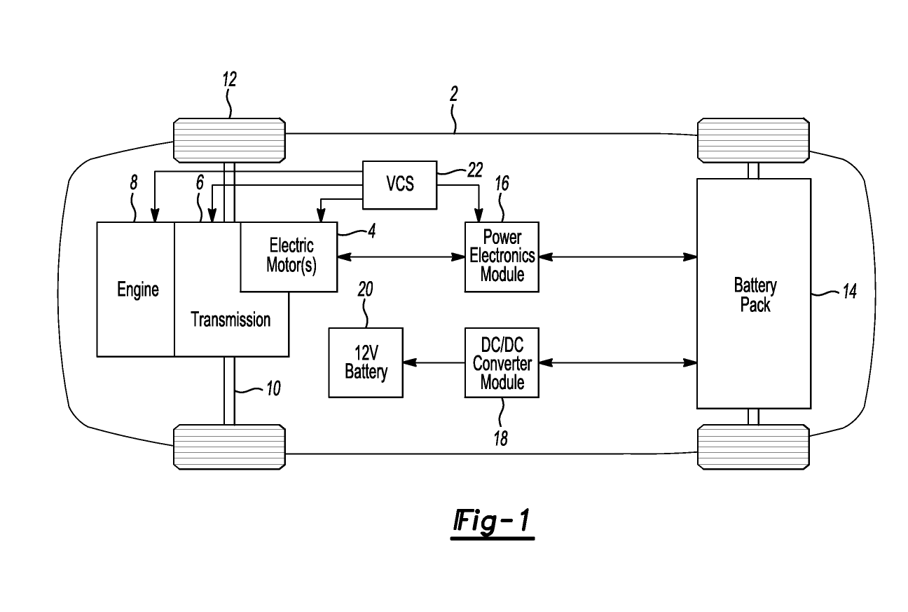

FIG. 1 depicts a typical hybrid-electric vehicle. A typical hybrid-electric vehicle 2 may comprise one or more electric motors 4 mechanically connected to a hybrid transmission 6. In addition, the hybrid transmission 6 is mechanically connected to an engine 8. The hybrid transmission 6 is also mechanically connected to a drive shaft 10 that is mechanically connected to the wheels 12. In another embodiment not depicted in the illustration, the hybrid transmission may be a non-selectable gear transmission that may include at least one electric machine. The electric motors 4 can provide propulsion and deceleration capability when the engine 8 is turned on or off. The electric motors 4 also act as generators and can provide fuel economy benefits by recovering energy that would normally be lost as heat in the friction braking system. The electric motors 4 may also provide reduced pollutant emissions since the hybrid electric vehicle 2 may be operated in electric mode under certain conditions.

A battery pack 14 may include a traction battery having one or more battery cells that store energy which can be used by the electric motors 4. The vehicle battery pack 14 typically provides a high voltage DC output and is electrically connected to a power electronics module 16 (e.g., at least one controller). The power electronics module 16 may communicate with one or more controller modules that make up a vehicle computing system 22. The vehicle computing system 22 may control several vehicle features, systems, and/or subsystems. The one or more controller modules may include, but are not limited to, a battery management system. The power electronics module 16 is also electrically connected to the electric motors 4 and provides the ability to bi-directionally transfer energy between the battery pack 14 and the electric motors 4. For example, a typical battery pack 14 may provide a DC voltage while the electric motors 4 may require three-phase AC current to function. The power electronics module 16 may convert the DC voltage to a three-phase AC current as required by the electric motors 4. In a regenerative mode, the power electronics module 16 will convert the three-phase AC current from the electric motors 4 acting as generators to the DC voltage required by the battery pack 14.

In addition to providing energy for propulsion, the battery pack 14 may provide energy for other vehicle electrical systems. A typical system may include a DC/DC converter module 18 that converts the high voltage DC output of the battery pack 14 to a low voltage DC supply that is compatible with other vehicle loads. Other high voltage loads may be connected directly without the use of a DC/DC converter module 18. In a typical vehicle, the low voltage systems are electrically connected to a 12V battery 20.

The battery pack 14 may be controlled by the power electronics module 16 which may receive commands from a vehicle computing system 22 having one or more controller modules. The one or more controller modules may include a battery control module. The one or more controller modules may be calibrated to control the battery pack 14 using a battery model parameter estimation method which estimates an average sense of effective battery internal resistance during operation to determine battery power capability. The power capability prediction enables the battery pack 14 to prevent over-charging and over-discharging.

The battery parameter prediction method and/or strategy may assist in determining battery current limits and power capability in real-time (i.e., during operation). Many battery parameter estimation processes are affected by the fidelity of battery models and unpredicted environmental conditions or unexpected noises during battery operations. The vehicle battery measurement method/strategy may use a battery model (e.g., equivalent circuit using one or more resistant-capacitor (R-C) circuits in several configurations) to measure the battery pack in the vehicle to obtain the electrochemical impedance during operation.

The calibration to control the battery pack may be accomplished using multiple tables to capture a wide frequency range that affects the impedance of the battery pack and its correlating dynamics. To populate/calibrate the multiple tables requires rigorous execution of offline testing of the battery pack in a test facility using complex algorithms. An example of offline testing of a battery pack is the Electrochemical Impedance Spectroscope (EIS) which may be implemented to capture the battery system characterization over wide frequency ranges that may include battery temperature, battery state of charge, and/or battery usage.

A vehicle battery measurement method may be implemented to eliminate the need for extensive offline testing. The vehicle battery measurement method may use one or more battery models to measure the battery pack in the vehicle to obtain battery parameters during operation. The vehicle battery measurement method may have a higher level of noise compared to EIS, however it may provide valuable information for characterizing the battery transient behavior during vehicle operation.

The HEV battery management method and/or system may implement one or more battery models to receive battery measurements for calculation of the electrochemical impedance and to estimate the battery parameters based on the impedance. The estimated battery parameters may include fluctuating trajectories which increase when the vehicle is in certain system modes including charging mode, sustaining mode, or depleting (i.e., discharging) mode. These battery parameters tend to be sensitive to internal and external noises and environmental conditions when using the one or more battery models to estimate these parameters in real time.

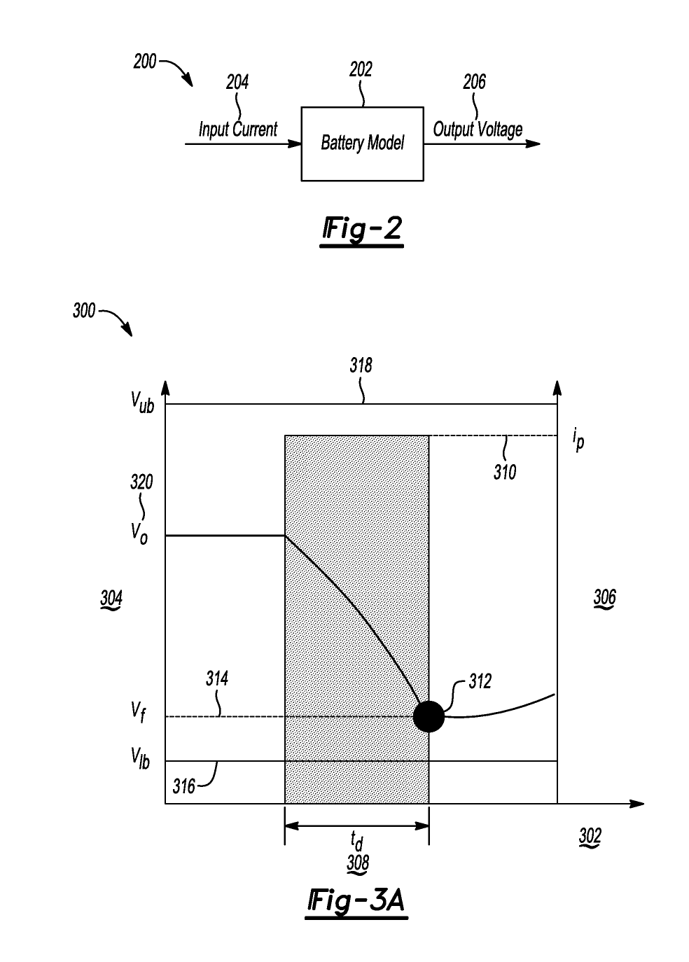

FIG. 2 is a schematic diagram 200 of a battery model 202 having current inputs 204 and voltage outputs 206 according to an embodiment. The battery model may include one or more models including, but not limited to, an electrochemical model, an equivalent circuit model (e.g., a Randles Circuit Model), a black box model (e.g., an autoregressive model, a moving average model, an autoregressive moving average model, a neural network model), and/or a combination thereof. The fidelity of battery response prediction may be improved as the complexity of the battery model system increases. An electrochemical model may provide the highest fidelity, but the computational time may take longer compared to other models. An equivalent circuit model may have a proper balance of computation time and prediction accuracy, but the valid region may be limited. A black box model may provide sufficient computational efficiency with high prediction accuracy, but it may be difficult to derive explicit expressions for battery current limit prediction and power limit prediction.

Battery power capability is affected by the impedance of the battery pack and its correlating dynamics. A system may receive the battery measurements and use the measurements to predict battery responses and performance during a period of time of upcoming operation of the battery. The prediction is generally possible using the battery model 200. The battery model 202 may consists of input current 204 and output voltage 206. Other inputs, such as temperature and battery state of charge (SOC), may be included depending on the model design. The battery model parameter estimation method may include battery measurement in the vehicle to obtain the battery output voltage 206 responses with the use of calculations/algorithms described in further detail below to output battery power capability. The measurement values may be recorded, calculated, and stored in one or more control modules in the vehicle computing system including the battery energy control module.

The input-to-output relations of a battery model may be extracted from any type of model using a method proposed in this disclosure. In one example, the system may implement a simplified battery model to predict battery current limits and power limits in real time during vehicle operation of the battery management system. However, there may be hybrid applications that require an improved battery capability prediction in battery controls. A certain battery model may be able to predict battery responses with high accuracy, but may be impossible or difficult to get explicit expressions to predict battery current limits and power limits.

The battery management system may predict battery responses expressed as a function of the applied battery current and calculate the maximum battery discharging and charging current from the derived function. The system is based on a statistical regression analysis of a set of injected current inputs to a battery model and a set of voltage outputs from the model. The statistical regression analysis enables one to find an explicit function relating an input current to an output voltage. The derived function is concise enough to predict battery current limits and power limits in real time in a battery management system, thus determining the maximum battery discharging and charging current from the derived function.

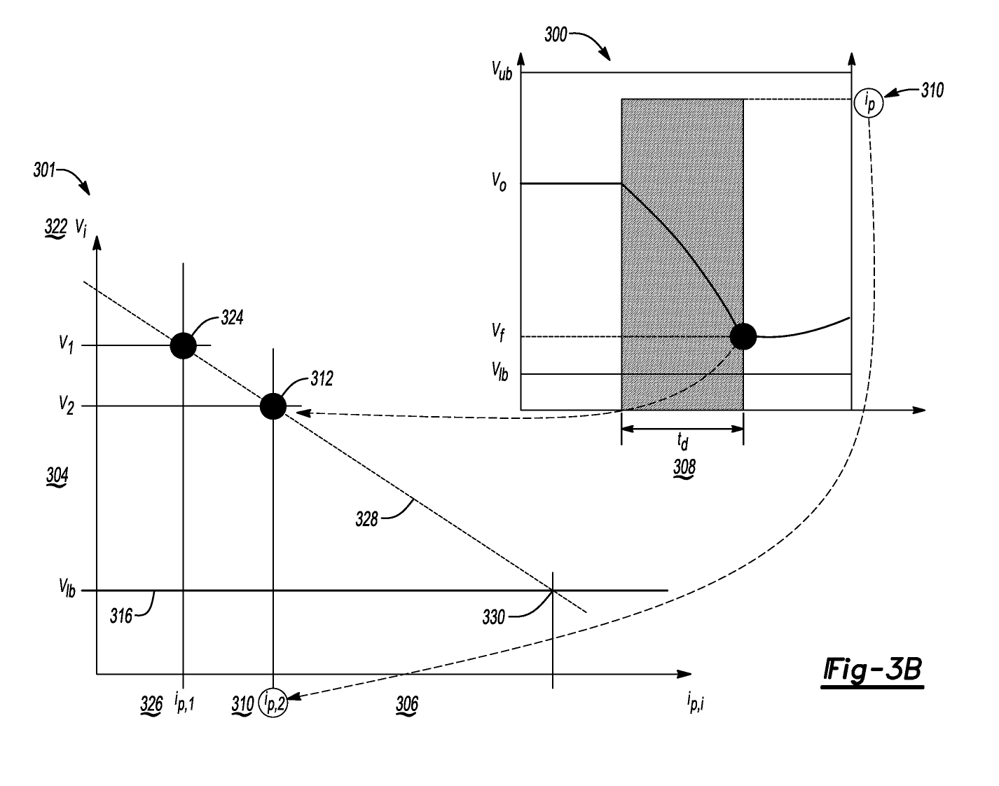

FIG. 3A is a graph 300 illustrating a procedure to identify the input-to-output relation of a battery model with an impulse current input having a time duration t_{d} 308 and a current magnitude iₚ 310. A voltage output response 320 of a battery model corresponds to the input current pulse 310. The graph 300 has an x-axis representing time 302, a first y-axis representing terminal output voltage 304, and a second y-axis representing battery input current magnitude 306. An initial current pulse input magnitude iₚ 310 is determined to make the battery terminal voltage 314 change significantly but not to exceed the battery terminal voltage limits. The battery terminal voltage limits include a lower voltage limit v_{lb} 316 for discharging and an upper voltage limit v_{ub} 318 for charging. The pulse time duration t_{d} 308 may be a predefined duration set to the time that the battery can provide power without violating the battery terminal voltage limits 316, 318 while ensuring desired battery operation.

The battery initial conditions may be estimated using a real-time state estimator, such as a Kalman filter and/or one or more pre-calibrated tables generated offline. The initial conditions are used to calculate the battery initial voltage vₒ 320. The battery terminal voltage v_{f} 314 is estimated from the battery model after the inject current input pulse duration 308 as the resulting battery terminal voltage 312.

FIG. 3B is a graph 301 illustrating a set of predicted battery model voltage responses with respect to a set of current inputs to identify the battery model dynamics. The graph has an x-axis representing battery input current magnitude 306 and a y-axis representing terminal output voltage 304. The y-axis illustrates several data points of vᵢ 322 of measured terminal voltage(s).

A set of battery terminal voltages are computed from a series of simulations using a battery model with respect to a set of battery current inputs. The set of injected current into the battery model are used to determine an appropriate regression equation to represent battery voltage responses corresponding with respect to the current inputs. For the system to obtain a function of the battery output voltage versus the battery input current, at least two data points are required. For example, the system may inject two current pulse inputs into the model and measure the corresponding output voltage. The set of current pulses may be within the limits corresponding to the upper and lower limits 316, 318 of the battery terminal output voltage.

An output voltage v₁ 324 is calculated based on an injected input current with a magnitude i_{p,1} 326. The next data point generated by the system is the resulting battery terminal voltage 312 calculated by assigning increased magnitude of input current to the battery model following the same procedure shown in FIG. 3A. As a result of having at least two terminal output voltages based on input current pulses, the system may extrapolate the output voltage to get a predicted output voltage response line 328 of the battery.

The battery current limits may be determined as the current magnitude that causes a battery voltage change to the battery voltage limit. Under discharging events, the battery voltage limit is the battery lower voltage limit 316. The discharge battery current limit 330 may be determined as a cross section of the extrapolated battery voltage line 328 and the lower limit voltage line 316.

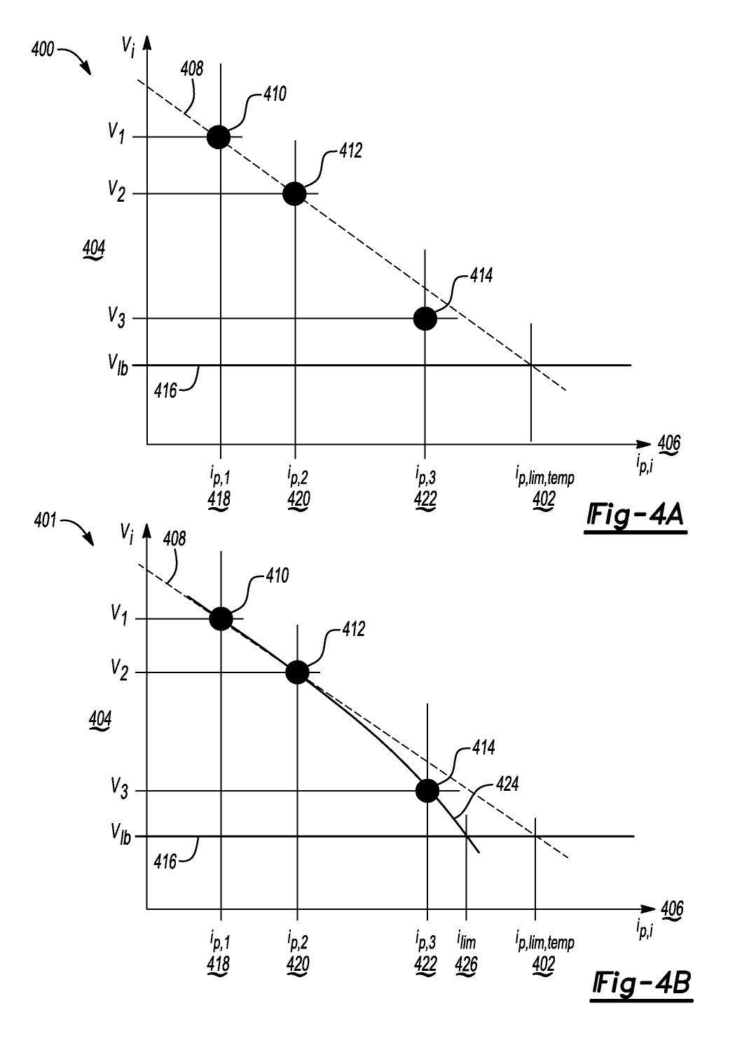

FIG. 4A is a graph 400 illustrating an example of predicted battery voltage responses with respect to a set of input current pulses. The graph has an x-axis representing battery current 406 and a y-axis representing terminal voltage 404. If the voltage responses are not linear, the system may require at least three points of data to capture the nonlinearity. These cases of nonlinearity may be more likely in a battery system during operation of a vehicle. The points are determined using the following procedure as described below.

The first two points 410, 412 on the graph 400 are predicted from the battery model by assigning two input currents 418, 420. The system may use the two point 410, 412 to generate a tentative battery current limit i_{lim,temp} 402 based on a calculated linearly extrapolated line 408 of the battery current versus terminal voltage data using the following equation:

$${i}_{li m , temp} = {i}_{p , 1} + ( \frac{{i}_{p , 2} - {i}_{p , 1}}{{v}_{2} - {v}_{1}} ) ( {v}_{l b} - {v}_{1} ) \qquad ( 1 )$$

wherein i_{lim,temp} is the tentative battery current limit. The tentative battery current limit may be used to calculate the lower limit voltage line 416.

The additional points may be used to find a regression equation capturing the nonlinear voltage response with respect to the input current. An additional current pulse magnitude i_{p,3} 422 is selected satisfying i_{p,2}<i_{p,3}<i_{lim,temp} and an additional battery terminal voltage v₃ 414 is computed by the system.

FIG. 4B is a graph 401 illustrating a regression curve 424 to predict the battery voltage responses with respect to current input and an estimated battery current limit during a discharge event. The regression curve 424 is obtained based on a generalized linear regression analysis. The generalized linear regression analysis uses a set of data comprising of explanatory variables (or independent variables) and response variables (or dependent variables) to identify the regression equation for the best fit of data. The explanatory variables may include the injected pulse input current magnitudes 418, 420, 422. The response variables may include the output voltage responses 410, 412, 414.

The determination of a new regression curve 424 during a discharging event allows the system to calculate a battery current limit 426 during real time operation. The battery current limit 426 takes into account the nonlinearity of the battery terminal voltage responses based on the discharging events. The system may assign a discharge lower limit voltage line 416 as a cross section of the new regression curve 424 and the lower limit voltage line 426.

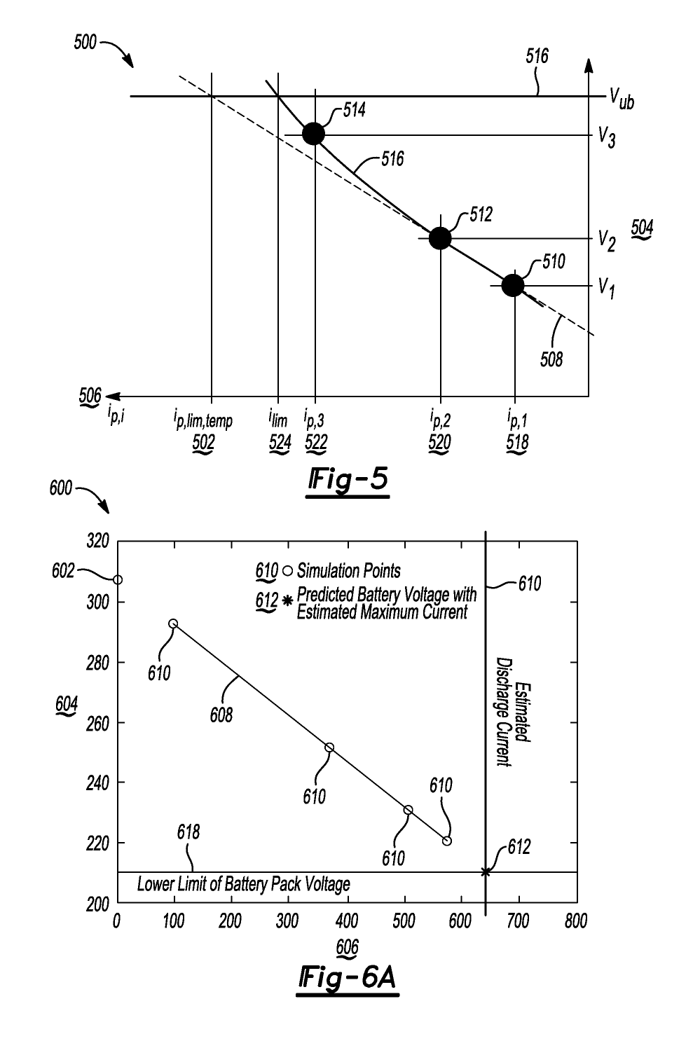

FIG. 5 is a graph illustrating a regression curve to predict the battery voltage responses with respect to a current input and an estimated battery current limit during a charge event. The battery voltage responses with respect to a current input are calculated based on pulse input current magnitudes set at time durations. The graph has an x-axis representing battery current 506 and a y-axis representing terminal voltage 504. The explanatory variables may include the pulse input current magnitudes 518, 520, 522. The response variables may include the output voltage responses 510, 512, 514.

As explained above, the system may use two point 510, 512 to generate a tentative battery current limit i_{lim,temp} 502 based on a calculated linearly extrapolated line 508 of the battery current versus terminal output voltage data using equation (1). The system may estimate the battery current limit iₗᵢₘ 524 and the upper limit voltage line 516 by the aforementioned procedure.

The coefficient of a regression model is computed from the following equation:

\hat{β}=(X^{T}X)⁻¹X^{T}y (2)

wherein \hat{β} is the estimated coefficients of a regression model, X is the matrix of the explanatory variables, and y is the vector of the response variable.

Nonlinearity of the battery voltage responses may be captured by the system including the use of a 2^{nd} order equation. If a 2^{nd} order equation is used to represent the output voltage responses, the voltage responses are expressed by using the following equation:

v=ai²+bi+c (3)

wherein v is the voltage response, i is the battery input current, and a, b, c are the model coefficients.

A set of current inputs are expressed using the following equations:

i=[i₁ . . . iₖ . . . iₙ]^{T} (4a)

i²=[i₁² . . . iₖ² . . . iₙ²]^{T} (4b)

A set of voltage outputs are expressed using the following equation:

y=v=[v₁ . . . vₖ . . . vₙ]^{T} (5)

wherein n is the number of data points.

The explanatory variable matrix X is constructed using the following equation:

$$\begin{matrix}X = [ \begin{matrix}1 & {i}_{1} & {i}_{1}^{2} \\ ⋮ & ⋮ & ⋮ \\ 1 & {i}_{k} & {i}_{k}^{2} \\ ⋮ & ⋮ & ⋮ \\ 1 & {i}_{n} & {i}_{n}^{2}\end{matrix} ] = [ {\begin{matrix}1 & i & i\end{matrix}}^{2} ] & ( 6 ) \\ wherein β = [ \begin{matrix}c & b & a\end{matrix} ] & ( 7 )\end{matrix}$$

The coefficient of the regression model is computed from the matrix in equation (6) and the vector in equation (5) using equation (2).

The current limit is computed from the identified regression equation (3) using the following equations:

$$\begin{matrix}{i}_{li m} = \frac{- b - 2 \sqrt{{b}^{2} - 4 a ( c - {v}_{l b} )}}{2 a} for discharging & ( 8 a ) \\ {i}_{l i m} = \frac{- b - \sqrt{{b}^{2} - 4 a ( c - {v}_{ub} )}}{2 a} for charging & ( 8 b )\end{matrix}$$

wherein iₗᵢₘ is the discharging current limit 426 and the charging current limit 524. The estimated coefficients of the regression model are calculated separately at the discharging and charging cases, i.e., the estimated coefficients are different for the discharging and charging cases.

For the special case of when the magnitude of a is close to zero, the current limit is calculated using the following equations:

iₗᵢₘ=(v_{lb}−c)/b for discharging (9a)

sₗᵢₘ=(v_{ub}−c)/b for charging (9b)

The system may calculate the battery instantaneous power capabilities during a charge event using the following equation:

Pₗᵢₘ=∥i_{chg,min}∥v_{ub} (10a)

wherein Pₗᵢₘ is the power capability, v_{ub} is the battery upper voltage limit, and i_{chg,min} is the absolute minimum current.

The system may calculate the battery instantaneous power capabilities during a discharge event using the following equation:

Pₗᵢₘ=∥i_{dch,max}∥v_{lb} (10b)

wherein Pₗᵢₘ is the power capability, v_{lb} is the battery lower voltage limit, and i_{dch,max} is the maximum current.

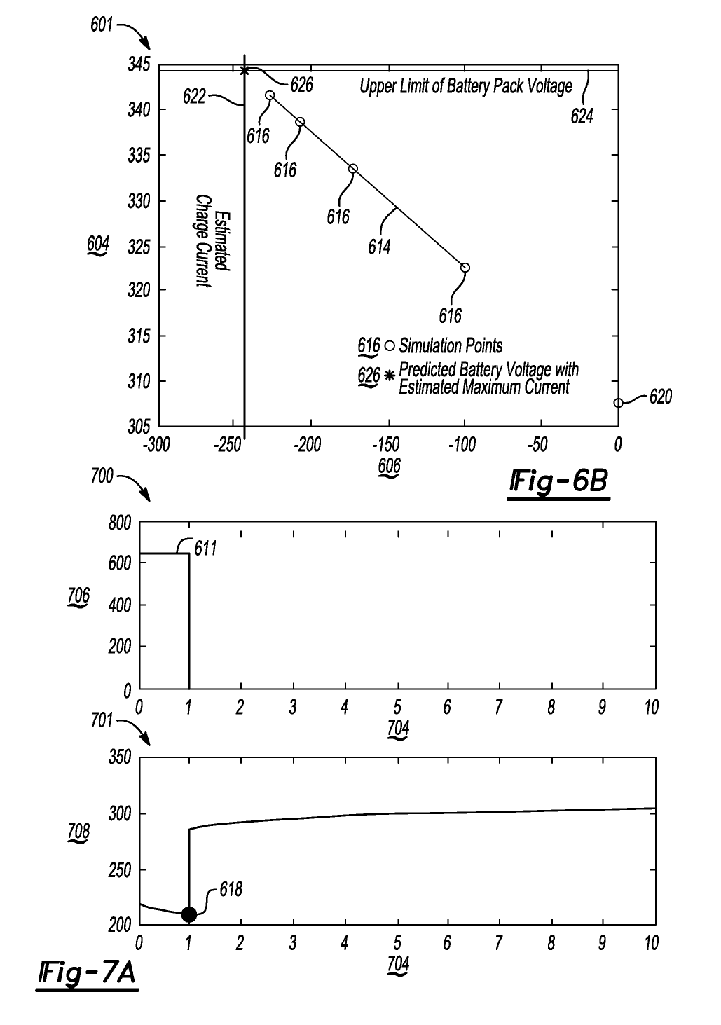

FIGS. 6A-6B are graphs illustrating a set of predicted battery voltage responses of a battery model with respect to a set of current inputs to the model and estimated maximum and minimum currents. As shown in FIG. 6A, the graph 600 illustrates a maximum discharge battery current estimation having an x-axis 606 representing current in amperes and a y-axis 604 representing terminal voltage in volts.

The voltage outputs of a battery model with respect to a set of input currents are depicted in FIG. 6A as data points 610. Data points 610 are obtained by applying a set of current inputs to the battery model having an initial voltage 602 at the corresponding time step. A regression equation is derived from the set of simulation data points 610 to generate a regression line 608. The system may extrapolate the regression line to predict the battery voltage 612 with estimated maximum current 611. The system may output a lower limit voltage line 618 as a cross section of the predicted battery voltage 612 and the lower limit voltage line 611.

The same approach is used to predict battery charge current limit as shown in FIG. 6B. The graph 601 illustrates a minimum charge current estimation having an x-axis 606 representing current in amperes and a y-axis 604 representing terminal voltage in volts. The applying input current pulse magnitudes are simulated data points 616 that the system uses to calculate the regression line 614. The system extrapolates the regression line 614 to predict the battery current limit 622. The predicted battery voltage with minimum current limit 626 is used to set the upper limit 624 of the battery pack voltage.

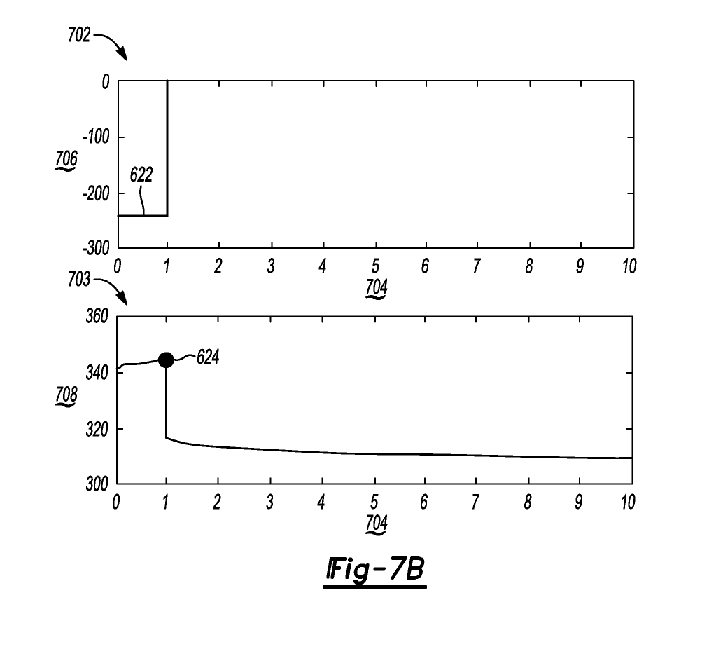

FIGS. 7A-7B illustrate the validation of the predicted battery voltage responses applied with the estimated battery current limits. For a discharging case in FIG. 7A, the discharging current limit is shown on graph 700 having an x-axis 704 representing time and a y-axis 706 representing current. The discharging current is estimated as i_{dch,max} 611 as shown in FIG. 6A. The predicted voltage response of the estimated discharge current is shown in graph 701 having an x-axis 704 representing time and a y-axis 708 representing voltage. The terminal voltage output at the end of the current impulse duration with the applied input current pulse having the magnitude of i_{dch,max} 612 is equal to the v_{lb} 618 generated as the predicted voltage response as shown in FIG. 6A.

For a charging case as illustrated in FIG. 7B, the charging current limit is shown on graph 702 having an x-axis 704 representing time and a y-axis 706 representing current. The charging current is estimated as i_{chg,min} 622 as shown in FIG. 6B. The predicted voltage response of the estimated charge current is shown in graph 703 having an x-axis 704 representing time and a y-axis 708 representing voltage. The terminal voltage output at the end of the current impulse duration with the applied input current pulse having the magnitude of i_{chg,max} 626 is equal to the v_{ub} 624 generated as the predicted voltage response as shown in FIG. 6B.

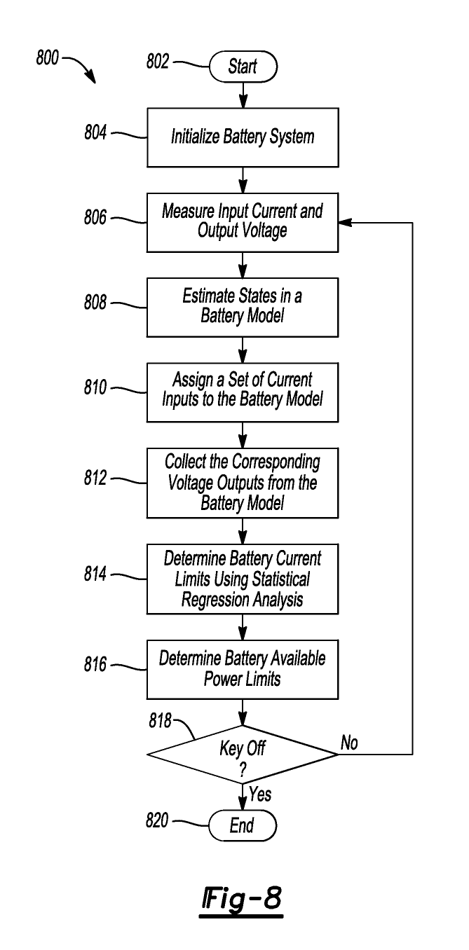

FIG. 8 is a flow chart of an algorithm for estimating battery current limits and power limits in a battery management system according to an embodiment. The method 800 is implemented using software code contained within the vehicle control module. In other embodiments, the method 800 is implemented in other vehicle controllers, or distributed amongst multiple vehicle controllers.

Referring again to FIG. 8, the vehicle and its components illustrated in FIG. 1 and FIG. 2 are referenced throughout the discussion of the method 800 to facilitate understanding of various aspects of the present disclosure. The method 800 of controlling the battery parameter prediction in the hybrid electric vehicle may be implemented through a computer algorithm, machine executable code, or software instructions programmed into a suitable programmable logic device(s) of the vehicle, such as the vehicle control module, the hybrid control module, another controller in communication with the vehicle computing system, or a combination thereof. Although the various steps shown in the flowchart diagram appear to occur in a chronological sequence, at least some of the steps may occur in a different order, and some steps may be performed concurrently or not at all.

At step 802, during a key-on event which allows the vehicle to be powered on, the vehicle computing system may begin powering up the one or more controller modules. The powering up of the one or more controller modules may cause variables related to the battery management system to initialize before enabling one or more algorithms used to control the battery at step 804.

The initialized parameters may be predetermined values or stored values at the last key off event. Before enabling the algorithms at a key-on event, the parameters should be initialized. For example, the battery management method may initialize several variables including, but not limited to, the battery terminal voltage, current limits, and/or other battery related parameters.

At 806, the system may measure the battery voltage outputs and current inputs using several types of sensors. Using a model parameter estimation method, such as Kalman filter, the battery model parameters may be estimated in real time at step 808. If real-time model parameter estimation is not necessary during a short period time, this step may be omitted.

At step 810, the system may assign a set of current inputs having a pulse magnitude set at predetermined time durations to inject into the battery model. The system may collect the corresponding output voltages from the battery model based on the pulse magnitude input current at step 812.

At step 814, the system may determine battery current limits using the regression model derived from the statistical regression analysis of the collected corresponding output voltages. Based on the regression model, the system may determine battery available power limits at step 816. The available power limits may be calculated as shown in equations (9) and (10).

At step 818, if the system detects a key-off event, the system may end the one or more algorithms used to manage the battery pack and/or the one or more battery cells. The vehicle computing system may have a vehicle key-off mode to allow the system to store one or more parameters in nonvolatile memory such that these parameters may be used by the system for the next key-on event at step 820.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a battery pack; and
at least one controller programmed to provide injection current inputs to a model configured to simulate, in response to the inputs, terminal voltage outputs of the battery pack, and to output power limits for the battery pack based on a regression of the injection current inputs and terminal voltage outputs.

2. The vehicle of claim 1, wherein the at least one controller is further programmed to apply an Extended Kalman Filter to the terminal voltage outputs to estimate parameters of the model.

3. The vehicle of claim 1, wherein the power limits are computed at a same time step or a sampled time step of the at least one controller to control the battery pack.

4. The vehicle of claim 1, wherein magnitudes of the injection current inputs fall within limits corresponding to upper and lower limits of the terminal voltage outputs.

5. The vehicle of claim 4, wherein a time duration of the injection current inputs correspond to a time duration associated with computation of the power limits.

6. The vehicle of claim 4, wherein the upper and lower limits of the terminal voltage outputs are battery operation voltage limits or predetermined values falling within the battery operation voltage limits.

7. The vehicle of claim 1, wherein the power limits include a discharging power limit or a charging power limit.

8. The vehicle of claim 1, wherein the at least one controller is further programmed to output voltage limits for the battery pack based on the regression of the injection current inputs and terminal voltage outputs.

9. The vehicle of claim 8, wherein the voltage limits include a maximum voltage limit or a minimum voltage limit.

10. A battery management method comprising:
generating, by a model representing a traction battery pack implemented within a controller, terminal voltage outputs in response to injection current inputs;
outputting current limits for the traction battery pack based on a regression of the injection current inputs and terminal voltage outputs; and
outputting power limits for the traction battery pack based on the current limits.

11. The method of claim 10 further comprising applying an Extended Kalman Filter to the terminal voltage outputs to estimate parameters of the model.

12. The method of claim 10, wherein the current limits are computed at a same time step or a sampled time step of the controller to control the traction battery pack.

13. The method of claim 10, wherein magnitudes of the injection current inputs fall within limits corresponding to upper and lower limits of the terminal voltage outputs.

14. The method of claim 13, wherein the upper and lower limits of the terminal voltage outputs are battery operation voltage limits or predetermined values falling within the battery operation voltage limits.

15. The method of claim 10, wherein the current limits include a discharging current limit or a charging current limit.

16. A hybrid powertrain system comprising:
a battery pack having one or more battery cells; and
at least one controller programmed to
provide input to a model of the battery pack representing a set of injection currents to cause the model to produce output representing terminal voltages of the battery pack, and
generate current limits for the battery pack based on a regression of the input and output.

17. The system of claim 16, wherein the at least one controller is further configured to generate power limits for the battery pack based on the current limits.

18. The system of claim 16, wherein upper and lower limits of the terminal voltages are battery operation voltage limits or predetermined values falling within the battery operation voltage limits.

19. The hybrid powertrain system of claim 16, wherein the current limits include a discharging current limit or a charging current limit.
